(19) United States
(12) Patent Application Publication
(10) Pub. No.: US 2015/0188225 A1
(43) Pub. Date: Jul. 2, 2015

(54) ANTENNA ASSEMBLY AND WIRELESS COMMUNICATION DEVICE USING THE SAME

(71) Applicant: Chiun Mai Communication Systems, Inc., New Taipei (TW)

(72) Inventors: TZE-HSUAN CHANG, New Taipei (TW); CHO-KANG HSU, New Taipei (TW)

(21) Appl. No.: 14/570,013

(22) Filed: Dec. 15, 2014

(30) Foreign Application Priority Data
Dec. 31, 2013 (CN) 201310749002.6

(51) Int. Cl. H01Q 5/335; H01Q 1/24; H01Q 1/22

(52) U.S. Cl. CPC H01Q 5/335; H01Q 1/2291; H01Q 1/243

(57) ABSTRACT

An antenna assembly includes a radiator, a first feed end, a second feed end, a ground end, and a matching network. The first feed end is connected to the radiator. The second feed end is connected to the radiator and is spaced from the first feed end. The ground end is connected to the radiator. The matching network has a first matching unit coupled to the first feed end and a second matching unit coupled to the second feed end. The first matching unit matches an impedance of the antenna assembly resonating a first frequency mode, and the second matching unit matches an impedance of the antenna assembly resonating a second frequency mode.

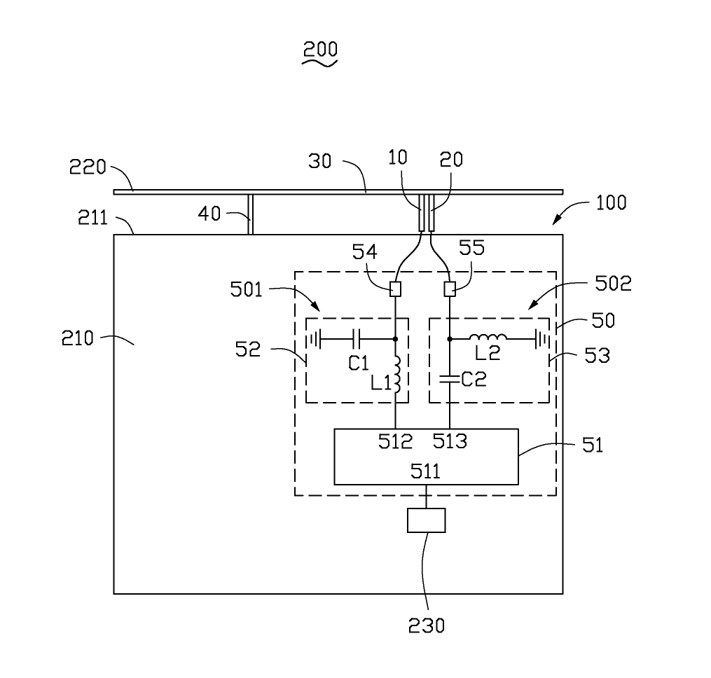

### FIELD

The disclosure generally relates to antenna assemblies, and particularly to a multiband antenna assembly and a wireless communication device using the same.

### BACKGROUND

Antennas are widely used in wireless communication devices such as mobile phones. A wireless communication device may use a multiband antenna to receive or transmit wireless signals at different frequencies, such as wireless signals operated in a wireless-fidelity (WI-FI) band.

### BRIEF DESCRIPTION OF THE DRAWINGS

Implementations of the present technology will now be described, by way of example only, with reference to the attached FIGURE.

The FIGURE is a diagrammatic view of a wireless communication device employing an antenna assembly, according to an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to an antenna assembly and a wireless communication device using same.

The FIGURE illustrates an embodiment of a wireless communication device 200 employing an antenna assembly 100, according to an exemplary embodiment. The wireless communication device 200 can be a mobile phone, a tablet, or an intelligent watch, for example (details not shown).

The wireless communication device 200 can further include a baseboard 210, a metallic housing 220, and a transceiver 230. The baseboard 210 includes an edge 211 spaced from the metallic housing 220. The transceiver 230 is mounted on the baseboard 210 and is electronically connected to the antenna assembly 100. In at least one embodiment, the baseboard 210 can be a printed circuit board (PCB) of the wireless communication device 200, and the transceiver 230 can be a wireless-fidelity (WI-FI) chip.

In at least one embodiment, the antenna assembly 100 can be a dual-band antenna. The antenna assembly 100 includes first feed end 10, a second feed end 20, a radiator 30, a ground end 40, and a matching network 50. The radiator 30 can be a part of the metallic housing 220. The first feed end 10 is parallel to the second feed end 20, and both the first feed end 10 and the second feed end 20 are perpendicularly connected to the radiator 30. The ground end 40 is disposed away from the first feed end 10, and is perpendicularly connected between the radiator 30 and the edge 211 of the baseboard 210. Thus, the antenna assembly 100 can be grounded via the ground end 40.

The matching network 50 can be a three-port network, and is coupled to the transceiver 230, the first feed end 10, and the second feed end 20. Thus, the matching network 50 can be configured to match an impedance of the antenna assembly 100, for optimizing performance of the antenna assembly 100 when the antenna assembly 100 operates at WIFI dual-band, such as 2.4-2.485 GHz and 5.15-5.85 GHz.

The matching network 50 includes a first matching unit 501 and a second matching network 502. The first matching unit 501 is configured to match an impedance of the antenna assembly 100 when then antenna assembly 100 operates at 2.4-2.485 GHz. The first matching unit 501 includes a first matching circuit 52 and a first filter 54. The second matching unit 502 is configured to match an impedance of the antenna assembly 100 when the antenna assembly 100 operates at 5.15-5.85 GHz. The second matching unit 502 includes a second matching circuit 53 and a second filter 55.

The matching network 50 further includes a frequency divider 51. The frequency divider 51 includes a first port 511, a second port 512, and a third port 513. The first port 511 serves as a radio frequency (RF) input port, and is coupled to the transceiver 230. The second port 512 and the third port 513 serve as RF output ports. The first matching circuit 52 is coupled to the second port 512, and the second matching circuit 53 is coupled to the third port 513. The first filter 54 is coupled between the first matching circuit 52 and the first feed end 10, and the second filter 55 is coupled between the second matching circuit 53 and the second feed end 20. In at least one embodiment, a circuit between the first port 511 and the second port 512 is equivalent to a low pass filter (LPF) to allow signals having a frequency of below about 3.5 GHz to pass, and a circuit between the first port 511 and the third port 513 is equivalent to a band pass filter (BPF) to allow signals having a frequency of about 4.9-6.5 GHz to pass.

In detail, the first matching circuit 52 includes a first inductor L1 and a first capacitor C1. The first inductor L1 and the first filter 54 are electronically coupled between the second port 512 and the first feed end 10 in series. A first end of the first capacitor C1 is coupled between the first inductor L1 and the first filter 54, and a second end of the first capacitor C1 is grounded. The second matching circuit 53 includes a second inductor L2 and a second capacitor C2. The second capacitor C2 and the second filter 55 are electronically coupled between the third port 513 and the second feed end 20 in series. A first end of the second inductor L2 is coupled between the second capacitor C2 and the second filter 55, and a second end of the second inductor L2 is grounded. In at least one embodiment, the first filter 54 is an LPF, and the second filter 55 is a high pass filter (HPF).

In use, the transceiver 230 outputs signals having a first frequency band and a second frequency band to the first port 511. The signals are divided by the frequency divider 51. Thus, the signals having the first frequency band are output from the second port 512, and the signals having the second frequency band are output from the third port 513.

The signals having the first frequency band pass through the first matching circuit 52 and the first filter 54, and then flow to the first feed end 10, the radiator 30, and are grounded via the ground end 40 for resonating a first frequency mode. Since the first matching circuit 52 is coupled to the radiator 30, thus, the first frequency mode can be adjusted to allow the antenna assembly 100 to receive/transmit the signals having the first frequency band, such as 2.4-2.485 GHz.

The signals having the second frequency band pass through the second matching circuit 53 and the second filter 55, and then flow to the second feed end 20, the radiator 30, and are grounded via the ground end 40 for resonating a second frequency mode. Since the second matching circuit 53 is coupled to the radiator 30, thus, the second frequency mode can be adjusted to allow the antenna assembly 100 to receive/transmit the signals having second frequency band, such as 5.15-5.85 GHz.

In addition, the second filter 55 is coupled between the second feed end 20 and the second inductor L2 to isolate the signals having the first frequency band. Thus, the signals having the first frequency band will not be electronically coupled to the second feed 20 to be grounded via the second inductor L2. Similarly, the first filter 54 is coupled between the first feed end 20 and the first capacitor C1 to isolate the signals having the second frequency band. Thus, the signals having the second frequency band will not be electronically coupled to the first feed end 10 to be grounded via the first capacitor C1. That is, the signals having the first frequency band and the second frequency band will not interfere with each other.

In summary, the matching network 50 is involved in the antenna assembly 100 to match an impedance of the antenna assembly 100 for achieving a first frequency band and a second frequency band. Thus, the wireless communication device 200 has good performance when operating at 2.4-2.485 GHz and 5.15-5.85 GHz. In addition, a radiating capability of the antenna assembly 100 of the wireless communication device 200 is effectively improved because of the matching network 50.

The embodiments shown and described above are only examples. Many details are often found in the art such as the other features of the antenna assembly and the wireless communication device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. An antenna assembly comprising:
a radiator;
a first feed end connected to the radiator;
a second feed end connected to the radiator and spaced from the first feed end;
a ground end connected to the radiator; and
a matching network having a first matching unit coupled to the first feed end and a second matching unit coupled to the second feed end,
wherein the first matching unit matches an impedance of the antenna assembly for resonating a first frequency mode, and the second matching unit matches an impedance of the antenna assembly for resonating a second frequency mode.

2. The antenna assembly as claimed in claim 1, wherein the matching network further comprises a frequency divider, the frequency divider includes a first port, a second port, and a third port, the first port is coupled to a transceiver, the second port is coupled to the first matching unit, and the third port is coupled to the second matching unit.

3. The antenna assembly as claimed in claim 2, wherein the first matching unit comprises a first matching circuit and a first filter, the first matching circuit is coupled between the second port and the first filter, and the filter is coupled to the first feed end to allow signals of first frequency to pass.

4. The antenna assembly as claimed in claim 3, wherein the first matching circuit includes a first inductor and a first capacitor, the first inductor and the first filter are electronically coupled between the second port and the first feed end in series, a first end of the first capacitor is coupled between the first inductor and the first filter, and a second end of the first capacitor is grounded.

5. The antenna assembly as claimed in claim 4, wherein the first filter is a low pass filter (LPF).

6. The antenna assembly as claimed in claim 2, wherein the second matching unit comprises a second matching circuit and a second filter, the second matching circuit is coupled between the third port and the second filter, and the second filter is coupled to the second feed end to allow signals of second frequency to pass.

7. The antenna assembly as claimed in claim 6, wherein the second matching circuit includes a second inductor and a second capacitor, the second capacitor and the second filter are electronically coupled between the third port and the second feed end in series, a first end of the second inductor is coupled between the second capacitor and the second filter, and a second end of the second inductor is grounded.

8. The antenna assembly as claimed in claim 7, wherein the second filter is a high pass filter (HPF).

9. A wireless communication device comprising:
a baseboard;
a transceiver;
a metallic housing; and
an antenna assembly comprising:
a first feed end connected to the metallic housing;
a second feed end connected to the metallic housing and spaced from the first feed end;
a ground end connected to the metallic housing; and
a matching network comprising:
a first matching unit coupled to the first feed end;
a second matching unit coupled to the second feed end; and
a frequency divider coupled to the transceiver, the first matching unit, and the second matching unit.

10. The wireless communication device as claimed in claim 9, wherein the frequency divider includes a first port, a second port, and a third port, the first port is coupled to the transceiver, the second port is coupled to the first matching unit, and the third port is coupled to the second matching unit.

11. The wireless communication device as claimed in claim 10, wherein the first matching unit comprises a first matching circuit and a first filter, the first matching circuit is coupled between the second port and the first filter, and the first filter is coupled to the first feed end to allow signals of first frequency to pass.

12. The wireless communication device as claimed in claim 11, wherein the first matching circuit includes a first inductor and a first capacitor, the first inductor and the first filter are electronically coupled between the second port and the first feed end in series, a first end of the first capacitor is coupled between the first inductor and the first filter, and a second end of the first capacitor is grounded.

13. The wireless communication device as claimed in claim 10, wherein the second matching unit comprises a second matching circuit and a second filter, the second matching circuit is coupled between the third port and the second filter, and the second filter is coupled to the second feed end to allow signals of second frequency to pass.

14. The wireless communication device as claimed in claim 13, wherein the second matching circuit includes a second inductor and a second capacitor, the second capacitor and the second filter are electronically coupled between the third port and the second feed end in series, a first end of the second inductor is coupled between the second capacitor and the second filter, and a second end of the second inductor is grounded.
